(19) United States
(12) Patent Application Publication
(10) Pub. No.: US 2003/0035094 A1
(43) Pub. Date: Feb. 20, 2003

(54) Reaction force isolation frame

(76) Inventors: Andrew J. Hazelton, San Carlos, CA (US); Douglas C. Watson, Campbell, CA (US); Michael Binnard, Belmont, CA (US)

Correspondence Address: LIU & LIU LLP, 811 WEST SEVENTH STREET, SUITE 1100, LOS ANGELES, CA, 90017, US

(21) Appl. No.: 09/932,410

(22) Filed: Aug. 17, 2001

(51) Int. Cl. G03B 27/58

(52) U.S. Cl. 355/72; 355/75; 355/76; 355/53; 318/687; 310/10; 310/12

(57) ABSTRACT

A reaction frame structure for isolating the vibrations induced by reaction forces from stage motions, such as for a guideless stage. The reaction frame supports the driving motors in a manner whereby the reaction frame is structurally decoupled from the stage (e.g., by a slidable coupling) at least with respect to reaction forces in one direction of motion. In one embodiment, the fixed portion of the drive devices for effecting stage motion in a first direction is coupled to the reaction frame by a slidable coupling. The reaction frame is coupled to ground. The rest of the system including the stage is isolated from ground by deploying a vibration isolation system. A spring damper absorbs the reaction forces of the drive devices in the first direction. In another embodiment, the reaction frame is slidably supported on the same base as the stage. Dampers may be provided to the reaction frame along the first direction and/or a second orthogonal direction.

### BACKGROUND OF THE INVENTION

1. Field of the Invention

The present invention relates generally to electromechanical alignment and isolation, and more particularly, to a method and apparatus for supporting and aligning a wafer relative to a reticle in a photolithographic system with a motor and isolating the aligned components from the reaction forces from the motor.

2. Related Background Art

Various support and positioning structures are available for positioning an article for precision processing. For example in semiconductor manufacturing, a wafer and reticle are precisely positioned relative to an exposure apparatus such as a photolithographic apparatus. Planar or linear motors are typically used to position and align the reticle and wafer for exposure in the photolithographic apparatus. Conventional planar motors used in semiconductor manufacturing are disclosed in U.S. Pat. Nos. 4,535,278 and 4,555,650, for example.

A semiconductor device is typically produced by overlaying or superimposing a plurality of layers of circuit patterns on the wafer. The circuit pattern is first formed in a reticle and transferred into a surface layer of the wafer through photolithography. This requires precise alignment of the wafer relative to the reticle during the photolithography process.

A typical photolithography apparatus includes an illumination source, a reticle stage assembly retaining a reticle, a lens assembly and a wafer stage assembly (i.e., the object stage) retaining a semiconductor wafer. The reticle stage assembly and the wafer stage assembly are supported above a ground with an apparatus frame. Typically, the wafer stage assembly includes one or more motors to precisely position the wafer and the reticle stage assembly.

A typical wafer stage assembly includes a stage base, a first stage and a second stage. The stages move relative to the stage base to position the wafer. The first stage is used for relatively large movements of the wafer along a X axis. The second stage is used for relatively large movements of the wafer along a Y axis. Existing wafer stage assemblies typically include a fixed guide with an air bearing that inhibits the first stage from moving along the Y axis and rotating about a Z axis relative to the stage base. An example of such assembly is disclosed in U.S. Pat. No. 5,623,853. U.S. patent application Ser. No. 09/557,122, filed Apr. 24, 2000, discloses a guideless stage assembly that can be moved with complete freedom in the planar degrees of freedom.

Because the size and the images transferred onto the wafer from the reticle are extremely small, the precise relative positioning of the wafer and the reticle is critical to the manufacturing of high density, semiconductor wafers. Several sources may cause alignment errors. One source of alignment errors is vibration of the structures within the photolithographic system. The reaction forces between the moving portion and fixed portion of the motor induce vibrations in the system. As the circuit density of integrated circuits increases and feature size decreases, alignment errors must be further reduced or eliminated. Precise alignment of the overlays is imperative for high-resolution semiconductor manufacturing.

Various systems have been proposed which isolate the reaction force of the motors in the wafer stage. For example, patent publication no. WO 00/10058 discloses a structure for isolating the reaction forces generated by a planar motor, strategically using vibration isolation elements, and bearings to allow movement of parts to absorb reaction forces with their inertia. U.S. Pat. No. 5,528,118 to Lee discloses the use of a reaction force isolation frame that is mounted on a base structure independent of the base for a guideless object stage so that the object stage is supported in space independent of the reaction frame. The guideless stage provides additional degrees of freedom for the object stage. However, the actuator for the guideless stage imparts a reaction force on the support for the object stage.

It is desirable to develop a reaction frame structure that further reduces the effect of vibrations caused by the stage motors in a system having many degrees of freedom. By further reducing the reaction force induced vibrations, it would also be possible to design a multi-stage system in which movement of one stage would not adversely affect another stage.

### SUMMARY OF THE INVENTION

The present invention provides a structure for isolating the vibrations induced by reaction forces from stage motions under three degrees of movement in a plane. In particular, the reaction frame of the present invention isolates vibrations from motions of a guideless stage.

In one aspect of the present invention, a stage assembly comprises a reaction frame, which supports the driving devices in a manner whereby the reaction frame is structurally decoupled from the stage (e.g., by a slidable coupling) at least with respect to reaction forces in one direction of motion.

In accordance with one embodiment of the present invention, the fixed portion of the drive devices for effecting stage motion in a first direction is coupled to the reaction frame by a slidable coupling. The reaction frame is coupled to ground. The rest of the system including the stage is isolated from ground by deploying a vibration isolation system. A spring damper may be provided to absorb the reaction forces of the drive devices in the first direction.

In another embodiment, the reaction frame is slidably supported on the same base as the stage. The reaction frame reacts to reaction forces as a counter-mass. Additional dampers may be provided to the reaction frame along the first direction and/or a second orthogonal direction.

In a further embodiment of the present invention, the reaction frame of the present invention can isolate vibrations from movements of more than one stage in the same stage assembly.

More particularly, in one embodiment, the present invention is directed to a stage assembly, comprising a base; a stage slidably movable on the base, in first and second directions and rotation in a plane; a mover connected to the stage, the mover moving the stage in the plane, wherein reaction forces are created when the stage is being moved in the plane; and a reaction frame supporting the mover, the reaction frame being structurally decoupled from the base with respect to at least reaction forces in one of the first and second directions. Further, the reaction frame supports the mover in a manner whereby reaction forces in the first direction are structurally decoupled from the reaction frame, and the reaction frame supports the mover further in a manner whereby reaction forces in the second direction are supported by the reaction frame.

In another embodiment, the present invention is directed to a stage assembly, comprising a base; a stage slidably movable on the base; a first drive device having a relatively fixed portion and a first moving portion coupled to a moving member in a first direction, wherein reaction forces are created between the first fixed portion and the first moving portion when the moving member is being moved in the first direction; a second drive device having a second relatively fixed portion coupled to the moving member and a second moving portion coupled to a stage, the second drive device moving the stage in a second direction, wherein reaction forces are created between the second fixed portion and the second moving portion when the stage is being moved in the second direction; and a reaction frame supporting the fixed portions of the first drive device, wherein the reaction frame is structurally decoupled from the stage at least with respect to reaction forces in the first direction. Further, the stage assembly comprises a third drive device having a third relatively fixed portion supported on the reaction frame and a third moving portion coupled to the moving member, the third drive device moving the moving member in the second direction, wherein reaction forces are created between the third fixed portion and the third moving portion when the moving member is being moved in the second direction.

In another aspect of the present invention, an exposure system incorporates the stage assembly of the present invention. Further, a wafer is obtained on which an image is formed by such exposure system.

In a further aspect of the present invention, a device is manufactured using the exposure system that incorporates the stage assembly of the present invention.

### BRIEF DESCRIPTION OF THE DRAWINGS

FIG. 1 is a schematic representation of an exposure system that implements a reaction force isolation system in accordance with one embodiment of the present invention.

FIG. 2 is a perspective view of a wafer stage assembly adopting the reaction frame in accordance with one embodiment of the present invention.

FIG. 3 is a sectional view taken along line 3-3 in FIG. 2.

FIG. 4 is a perspective view of a wafer stage assembly adopting the reaction frame in accordance with another embodiment of the present invention.

FIG. 5 is a sectional view taken along line 5-5 in FIG. 4.

FIG. 6 is a perspective view of a wafer stage assembly adopting the reaction frame in accordance with yet another embodiment of the present invention.

FIG. 7 is a flow chart that outlines a process for manufacturing a device in accordance with one embodiment of the present invention.

FIG. 8 is a flow chart that outlines the process in more detail.

### DETAIL DESCRIPTION OF THE ILLUSTRATED EMBODIMENT

The following description is of the best-contemplated mode of carrying out the invention. This description is made for the purpose of illustrating the general principles of the invention and should not be taken in a limiting sense. The scope of the invention is best determined by reference to the appended claims.

To illustrate the principles of the present invention, the isolation of vibrations induced by reaction forces generated by a motor is described in reference to an exposure apparatus, and more specifically a photolithography system for substrate processing. However, it is understood that the present invention may be easily adapted for use in different types of exposure systems for substrate processing (e.g., scanning-type, step-and-scan type, projection-type and electron-beam photolithography systems), or other types of systems (e.g. pattern position measurement system disclosed in U.S. Pat. No. 5,539,521, wafer inspection equipment, machine tools, electron beam microscope) for processing other articles in which the reduction of vibrations induced by reaction forces generated in a motor is desirable without departing from the scope and spirit of the present invention.

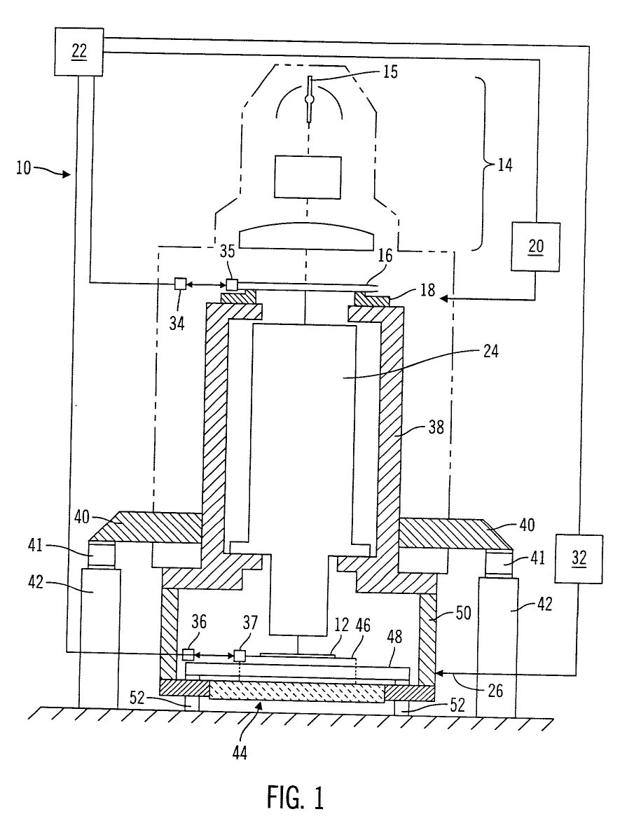

FIG. 1 is a schematic representation of an exposure system 10 for processing a substrate, such as a wafer 12, which implements the present invention. In an illumination system 14, light beams emitted from a lamp illumination source 15 (e.g., an extra-high pressure mercury lamp) are converged, collimated and filtered into substantially parallel light beams having a wavelength needed for a desired exposure (e.g., exposure of the photoresist on the wafer 12).

The light beams from the illumination system 14 illuminate a pattern on a reticle 16 that is mounted on a reticle stage 18. The reticle stage 18 is movable in several (e.g., three to six) degrees of freedom by servomotors or linear motors (not shown) under precision control by a driver 20 and a system controller 22. The light beams penetrating the reticle 16 are projected on the wafer 12 via projection optics 24.

The wafer 12 is held by vacuum suction on a wafer holder (not shown) that is supported on a wafer stage assembly 26 under the projection optics 24. The wafer stage assembly 26 is structured so that the wafer 12 can be moved in several (e.g., three to six) degrees of freedom by a series of linear motors (see discussion below) under precision control by the driver 32 and system controller 22, to position the wafer 12 at a desired position and orientation, and to move the wafer 12 relative to the projection optics 24. The driver 32 may provide the user with information relating to X, Y and Z positions as well as the angular positions of the wafer 12, and the driver 20 may provide user with information relating to the position of the reticle 16.

For precise positional information, interferometers 34 and 36 and mirrors 35 and 37 are provided for detecting the actual positions of the reticle and wafer, respectively, as schematically shown in FIG. 1. For either or each of the wafer stage and reticle stage, a set of three interferometers may be provided for detecting the X, Y and θ_{Z} (rotation about Z) positions of the wafer stage and/or reticle stage, so as to provide positional information that can be used to drive the wafer stage and/or reticle stage in the X and Y directions and θ_{Z}.

By way of example and not limitation, in a scanning-type exposure apparatus, the reticle 16 and the wafer 12 are scanned and exposed synchronously (in accordance with the image reduction in place) with respect to an illumination area defined by a slit having a predetermined geometry (e.g., a rectangular, hexagonal, trapezoidal or arc shaped slit). This allows a pattern larger than the slit-like illumination area to be transferred to a shot area on the wafer 12. After the first shot area has been completed, the wafer 12 is stepped by the linear motors to position the following shot area to a scanning start position. This system of repeating the stepping and scanning exposure is called a step-and-scan system. The scan-type exposure method is especially useful for imaging large reticle patterns and/or large image fields on the substrate, as the exposure area of the reticle and the image field on the wafer are effectively enlarged by the scanning process.

It is again noted that the configuration of the exposure system 10 described above generally corresponds to a step-and-scan exposure system that is known in the art. Further detail of the components within a scanning-type exposure apparatus may be referenced from U.S. Pat. No. 5,477,304 to Nishi and U.S. Pat. No. 5,715,037 to Saiki et al. (assigned to the assignee of the present invention, which are fully incorporated by reference herein.) It is to be understood that the present invention disclosed herein is not to be limited to wafer processing systems, and specifically to step-and-scan exposure systems for wafer processing. The general reference to a step-and-scan exposure system is purely for illustrating an embodiment of an environment in which the concept of isolation of motor reaction forces to reduce system vibration may be advantageously adopted. As illustrated in the FIG. 1, the illumination system 14, the reticle stage 18 and the projection optics 24 are supported by frames 38, 40 and 42. The frames are coupled to the “ground” (or the foundation on which the overall exposure system is supported). The frames 38, 40 and 42 may be coupled to the ground by means of vibration isolation systems and the like (e.g., dampers at 41). Vibration isolation systems are commercially available, for example, from Newport Corporation, Irvine, Calif.

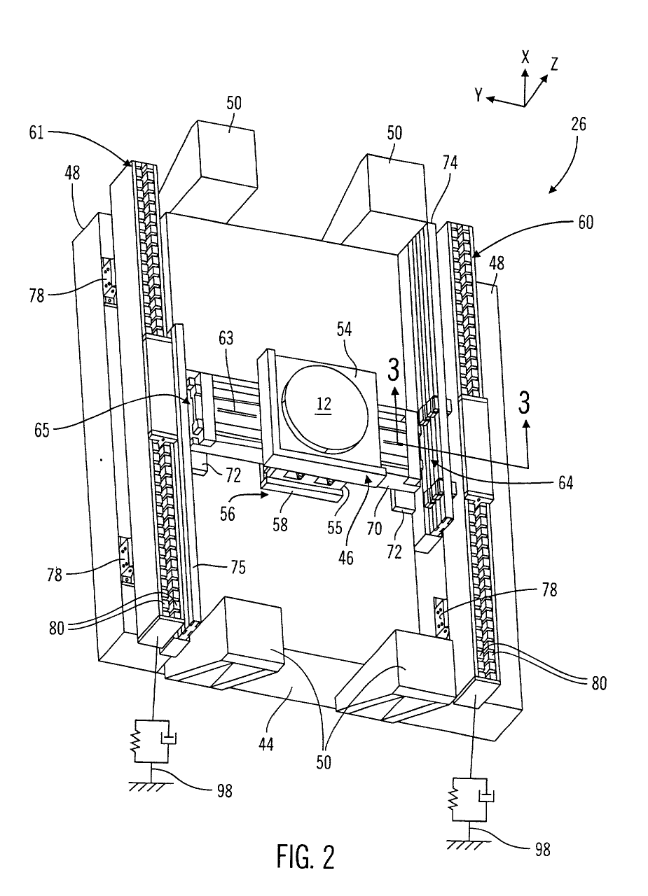

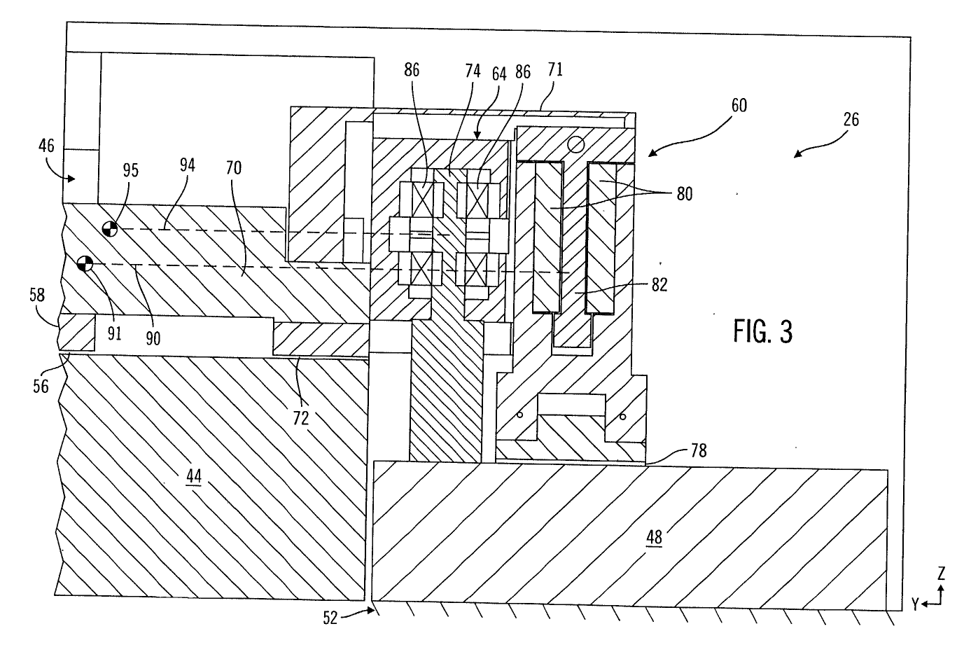

Referring also to FIGS. 2 and 3, the wafer stage assembly 26 is schematically illustrated. It comprises an object or wafer stage base 44, a wafer stage 46, actuators and reaction frames 48. The base 44 is supported from the frame 38 by depending frames 50. The reaction frames 48 are supported by support posts 52 that are mounted to ground or a separate base substantially free from transferring vibrations between the posts and the wafer stage 46.

The wafer stage 46 includes a wafer table 54 for supporting the wafer 12 (e.g., by means of a wafer chuck not shown in the illustrations) and a leveling stage 55. The wafer table 54 is levitated in the vertical plane for tilting motions by preferably three voice coil motors (not shown) in the leveling stage 55. The wafer stage 46 is supported in the space above the base 44 via vacuum pre-load type air bearings 56 acting against the foot 58 of the wafer stage 46. Alternatively, this support could employ a combination of magnets and coils that create a magnetic force to levitate the wafer table 54.

The wafer stage 46 is coupled to a guide bar 70, by air bearings (not shown) for movement in the Y-direction effected by a linear motor 63 along the axis of the guide bar 70. Each end of the guide bar 70 is coupled to a linear motor (60, 61), that together move the guide bar 70 in the X-direction (note: the coupling 71 is not shown in FIG. 2 but shown in FIG. 3). The linear motors 60 and 61 are supported on air bearings 78 on the reaction frame 48, which permit the linear motors to slide in the X-direction. The ends of the guide bar 70 ride on air bearings 72 on the base 44. The guide bar 70 is not restricted from movement within a small range in the Y-direction. This configuration is referred to as a guideless stage. Actuators 64 (structure not shown in FIG. 2 but shown in FIG. 3) is coupled to one end of the guide bar 70 to effect limited trimming motion of the guide bar 70 in the Y-direction. The actuator 64 is supported to ride along track 74, which is rigidly supported on one of the reaction frame 48. FIG. 2 shows a second track 75 is provided on the other of the reaction frames 48. This configuration is for handling a second wafer stage (not shown). An actuator 65 is supported to ride along second track 75, in the same way as the actuator 65 on track 74, and effects limited trimming motion of the guide bar of the second wafer stage in the Y-direction.

As can be seen from the drawings, by using actuators 64 and 65 on separate tracks 74 and 75, the reaction forces from the trimming motion of the guide bar of one wafer stage are isolated from the other wafer stage. For a single wafer stage system, the second track 75 and actuator 65 may be omitted from the system. Alternatively, more than one wafer stage may be coupled to the same track for Y-direction trimming. Further, two Y-direction actuators and corresponding tracks may be provided at both ends of each guide bar to effect Y-direction trimming motions.

In the embodiment illustrated, the linear motors 60, 61 and 63 and the actuators 64 and 65 are magnetic actuators. The linear motors 60, 61, 63 generate driving force by utilizing a Lorentz force. The actuators 64 and 65 generate driving force by utilizing a reactance force. By appropriately controlling the actuators using controller 22 (FIG. 1) the wafer table 54 can be precisely positioned with respect to the projection optics 24, to precisely position an image for exposure of photoresist on the wafer's surface.

In the embodiment shown, the effective range of the linear motors 60 and 61 extends longitudinally in the X-direction. Referring also to FIG. 3, the linear motors 60 and 61 each comprises a pair of linear arrays 80 of permanent magnets as the “stator”, and a coil 82 as the “mover” in the linear motor. The mover/coil 82 slides along the stator/array 80. The mover/coil 82 is attached to the guide bar 70 via coupling 71, and its movement is guided by air bearings 72 and the actuator 64. The linear motor 63 in the guide bar may be configured as a shaft type, commutated, linear motor similar to the linear motor disclosed in U.S. patent application Ser. No. 09/557,122, which is fully incorporated by reference herein.

The actuators 64, 65 each comprises a set of magnetic E-cores with coils 86 and a magnetic I-core, which is essentially the track (74, 75). When the coils on one side of the track are selectively energized, the I-core is magnetically attracted to the E-core on the energized side and moves laterally by a slight amount within the clearance in the space between the I-core (74, 75) and the E-core 86 pair. Alternatively, actuators 64 and 65 could employ a voice coil motor that comprises at least one magnet and at least one coil, and generates driving force by utilizing a Lorentz force. In this case, one of the magnet and the coil is coupled to the one end of the guide bar 70, and the other of the magnet and the coil is attached to track 74 or 75.

Together, by selectively actuating the linear motors 60, 61 and 63 and the actuators 64 and 65, the wafer stage 46 may be actuated to move in X, Y and θ_{Z} (rotation about Z), and together with the leveling stage 55, the wafer table 54 may be moved in a total of 6 degrees of freedom with respect to the base 44. Specifically, because the guide bar 70 is a guideless stage, by differentially actuating the linear motors 60 and 61, the wafer stage 46 may be rotated about Z.

It is noted that ideally, the line of action of the forces of the linear motors 60 and 61 should be in the same plane (represented by dotted line 90 in FIG. 3) as the combined center of gravity 91 of the wafer stage 46 (including the wafer table 54) and the guide bar 70. This is to ensure that the forces of the linear motors 60 and 61 do not cause a resultant rotational moment about the center of gravity 91 of the combined structure (a torque about Y) which may cause exposure misalignment.

Ideally, the line of action of the forces of the linear motor 63 in the guide bar 70 should be along the same plane 94 as the center of gravity 95 of the wafer stage 46 (including the wafer table 54). Likewise for the actuators 64 and 65, ideally their lines of action in the Y-direction should be in the same plane 94 as the center of gravity 95 of the wafer stage 46 including the wafer table 54. This would ensure that the forces from the linear motor 63 and actuators 64 and 65 would not cause a rotational moment about the center of gravity 95 of the wafer stage 46 (a torque about X) which may cause exposure misalignment. For the structure illustrated, the center of gravity 95 of the wafer stage 46 would be above the center of gravity 91 of the larger combined structure of the wafer stage 46 and the guide bar 70. Ideally, the two center of gravities 91 and 95 should be in the same plane to completely eliminate rotational moments from all the actuation forces. Since the combined structure of the guide bar 70 and wafer stage 46 is not a rigid integral structure, there may be residual torque induced by one component on another if the centers of gravity 91, 95 are not aligned. The relationships of actuation forces with respect of center of gravity are explained, for example, in U.S. Pat. No. 5,959,427 to Watson, and U.S. patent application Ser. No. 09/557,122, both fully incorporated by reference herein.

Because the linear motors 60 and 61 are supported on air bearings 78 for movement in the X-direction, when the X linear motors 60 and 61 are actuated to move the guide bar 70 and wafer stage 46, the linear motors 60 and 61 can slide in the X-direction in reaction to such movement. The inertia of the linear motors 60 and 61 can help to limit the extent of the X-direction sliding motion arising from the reaction force. Further, springs/dampers 98, coupled to ground, are provided at the ends of the linear motors to absorb reaction forces in the X-direction, and to dampen the high frequency vibration from a high frequency servo loop associated with the linear motors 60 and 61.

The Y actuators 64 and 65 impart their reaction forces in the Y-direction on the reaction frame 48, via the tracks 74 and 75 supported on the reaction frame 48. Further, the reaction forces of the linear motor 63 in the guide bar 70 imparts its reaction forces in the Y-direction on the guide bar 70, which in turn transmits such reaction forces to the Y actuators 64 and 65 connected thereto. The reaction frame 48 in effect supports the Y-direction reaction forces of the linear motor 63 via the Y actuators 64 and 65 and guide bar 70.

In this embodiment, the reaction frames 48 are structurally decoupled from the wafer stage by separating the wafer stage base 44 and the reaction frames 48, and the presence of the air bearing 78 decouples the reaction forces in the X-direction from the reaction frames 48. Because the structure of the reaction frames 48 is isolated from the base 44 on which the wafer stage 46 is supported, and the wafer stage is vibration isolated from ground, the reaction forces from the various actuators are effectively isolated from the wafer stage 46. It can be appreciated from the foregoing embodiment that the present invention provides a reaction force isolation system that isolates reaction forces from X, Y and θ_{Z} actuations from the rest of the system by grounding such reaction forces via the reaction frame and isolating the reaction frame from the rest of the system. The present invention is particularly useful to isolate reaction forces from actuations of the additional degrees of freedom in a guideless stage. The wafer stage assembly 26 may be adapted to accommodate more than one wafer stage on the base 44. The reaction forces attributed to each wafer stage are isolated in accordance with the present invention; and therefore do not adversely affect the other wafer stage(s).

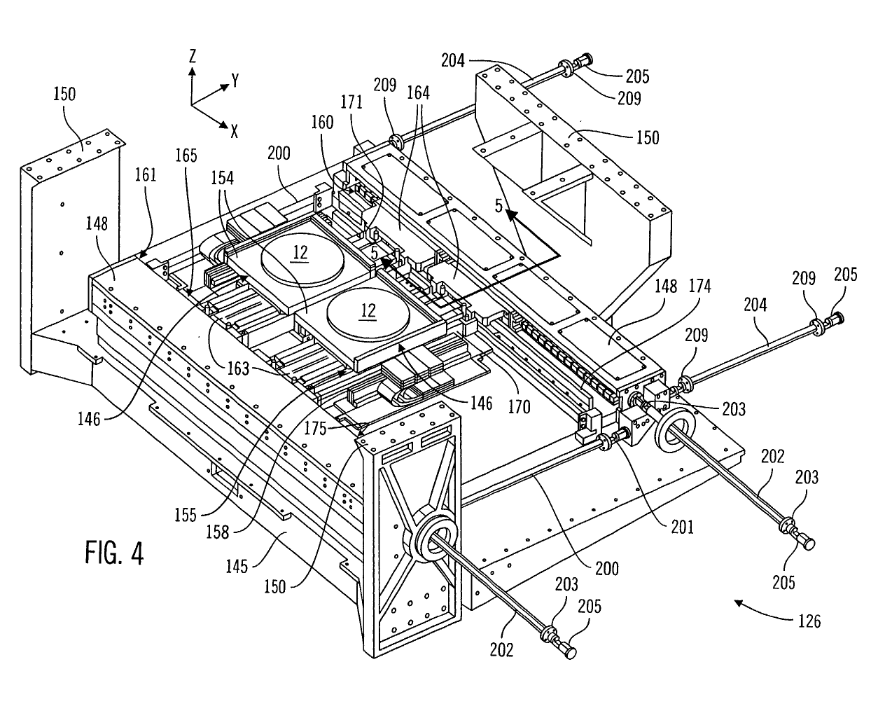

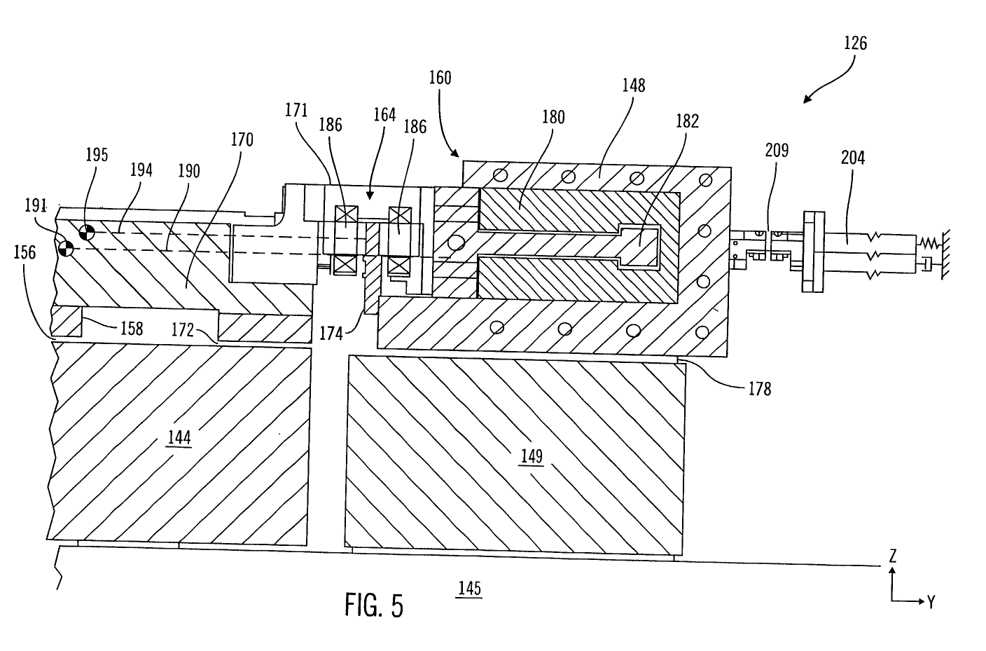

FIGS. 4 and 5 illustrate another embodiment of the present invention, which is directed to a wafer stage assembly 126 in which the reaction frames 148 and the wafer stage base 144 are supported by a common platform 145. In this embodiment, two wafer stages 146 are shown, but one or more wafer stages may be employed without departing from the scope and spirit of the present invention. The platform 145 is supported from the frame 38 (FIG. 1) by depending frames 150.

As in the previous embodiment, the wafer stage 146 includes a wafer table 154 for supporting the wafer 12 (e.g., by means of a wafer chuck not shown in the illustrations) and a leveling stage 155. The wafer stage 146 is supported in the space above the base 144 via vacuum pre-load type air bearings 156 acting against the foot 158 of the wafer stage 146. Alternatively, this support could employ a combination of magnet and coils that create a magnetic force to levitate the wafer table 154.

The wafer stage 146 is coupled to a guide bar 170, by air bearings (not shown) for movement in the Y-direction effected by a linear motor 163 along the axis of the guide bar 170. Each end of the guide bar 170 is coupled to a linear motor (160, 161), that together move the guide bar 170 in the X-direction. The linear motors 160 and 161 are supported within reaction frames 148 (see FIG. 5). The bases 149 of the reaction frames are supported on the common platform 145 that supports the wafer stage base 144. The ends of the guide bar 170 ride on air bearings 172 on the base 144. The guide bar 170 is allowed a small range of motion in the Y-direction (i.e., a guideless stage). For each wafer stage 146, an actuator 164 is provided at one end of the guide bar 170 to effect limited trimming motion of the guide bar 170 in the Y-direction. Each actuator 164 is supported to ride along track 174 that is rigidly supported on one of the reaction frames 148. The track 174 covers the entire span of travel of both guide bars 170 in the X-direction.

An optional track 175 and one or more actuators 165 (structures not shown) may be provided on the other one of the reaction frames 148, coupled to the other end of one or more of the guide bars 170 of the wafer stages 146. A number of configurations may be possible with two tracks 174 and 175. For example, the two ends of one or both guide bars 170 may be coupled to the two tracks 174 and 175. Alternatively, only one end of one of the guide bars 170 is coupled to track 174, and only one end of the other one of the guide bars is coupled to a different track 175. For a single wafer stage system, the second track 175 and actuator 165 may be omitted from the system.

In the embodiment illustrated, the linear motors 160, 161 and 163 and the actuator 164 are magnetic actuators. The linear motors 160, 161, and 163 generate driving force by utilizing a Lorentz force. The actuators 164 and 165 generate driving force by utilizing a reactance force. By appropriately controlling the actuators using controller 22 (FIG. 1), the wafer tables 154 can be precisely positioned with respect to the projection optics 24, to precisely position an image for exposure of a photoresist on the wafers' surfaces.

In the embodiment shown, the effective range of the linear motors 160 and 161 extends longitudinally in the X-direction. Referring also to FIG. 5, the linear motors 160 and 161 each comprises a pair of linear arrays 180 of permanent magnets as the “stator”, and a coil 182 as the “mover” in the linear motor, in similar configuration as the linear motors 60 and 61 in the previous embodiment, except that the linear motors 160 and 161 are oriented with the movers/coils horizontally. The mover/coil 182 slides along the stator/array 180. The mover/coil 182 is attached to the guide bar 170 via the actuator 164 and coupling 171, and its movement is guided by air bearings 172 and the actuator 164. The linear motor 163 in the guide bar may be configured as a shaft type, commutated, linear motor.

The actuator 164 comprises a set of magnetic E-cores 186 with coils 186 and a magnetic I-core, which is essentially the track 174. When the coils on one side of the track are selectively energized, the I-core is magnetically attracted to the E-core on the energized side and moves laterally by a slight amount within the clearance in the space between the I-core 174 and the E-core 186 pair. Alternatively, actuators 164 and 165 could employ a voice coil motor that comprises at least one magnet and at least one coil, and generates driving force by utilizing a Lorentz force. In this case, one of the magnet and the coil is coupled to one end of the guide bar 170, and the other of the magnet and the coil is attached to track 174 or 175.

Together, by differentially actuating the linear motors 160, 161 and 163 and the actuators 164 (and/or 165), each wafer stage 146 may be actuated to move in X, Y and θ_{Z} (rotation about Z), and together with the leveling stage 155, the wafer table 154 may be moved in a total of 6 degrees of freedom with respect to the base 144. Specifically, because the guide bar 170 is a guideless stage, by differentially actuating the linear motors 160 and 161, the wafer stages 146 may be rotated about Z.

For the same reasons as in the previous embodiment, the line of action of the forces of the linear motors 160 and 161 should be in the same plane (represented by dotted line 190 in FIG. 5) as the combined center of gravity 191 of the wafer stage 146 (including the wafer table 154) and the guide bar 170. Likewise for the linear motor 163 and the actuator 164, ideally the line of action in the Y-direction should be in the same plane 194 as the center of gravity 195 of the wafer stage 146 including the wafer table 154.

When the X linear motors 160 and 161 are actuated to move the guide bar 170 and wafer stage 146, the reaction frames 148 on which the linear motors are supported absorb the reaction forces imparted. The air bearings 178 allow in-plane motion of the ground, to which the reaction frames are attached, relative to the platform 145, thereby not imparting in-plane vibrations from the ground to the platform 145 and the wafer stages supported thereon. Since the reaction frames 148 are supported on air bearings 178, the inertia of the reaction frames 148 reduce somewhat the reaction forces imparted to ground which limit the extent of X-direction motion. The reaction frames 148 are parallel, separated by rods 200. The rods 200 have flexure couplings 201 at their ends connected to the reaction frames 148, which maintain the parallel geometry between the reaction frames and the separation between them. However, because of relative motion in the X-direction, the separation between the reaction frames 148 may possibly change, but only by a negligible amount. An example of a flexure coupling may be found in Flexures: Elements of Elastic Mechanisms by Stuart T. Smith, published by Gordon and Breach Science Publisher, 2000.

Further, rods 202, each having a flexible coupling 203 at each end, connect the end of a reaction frame 148 to ground via a damper/spring 205. The rods 202 transmit the reaction forces acting on the reaction frames 148 in the X-direction to ground where they are absorbed. The flexible coupling 203 allows for limited motion of the reaction frame 148 in the Y and Z directions. The springs 205 dampen the high frequency vibrations from a high frequency servo loop associated with the linear motors 160 and 161.

Similarly, the Y actuator 164 imparts its reaction forces in the Y-direction on the reaction frame 148, via the track 174 supported on the reaction frame 148. Further, the reaction forces of the linear motor 163 in the guide bar 170 imparts its reaction forces in the Y-direction on the reaction frame 148 through guide bar 170 and actuator 164, similar to the previous embodiment. Rods 204, similar to rods 202, and including flexible couplings 209 are provided on the longitudinal side of the reaction frame 148 that has the actuator 164 and are connected to ground. The flexible coupling 209 allows for limited motion of the reaction frame 148 in the X and Z directions. The rods 204 transmit the reaction forces on the reaction frame 148 in the Y-direction to ground, where they are absorbed. In another embodiment, the rods 204 are provided with damper/springs 205 for ground connection. The springs 205 dampen any high frequency vibrations associated with the linear motors 163 for the wafer stages 146.

In this embodiment, the reaction frame is structurally decoupled from the wafer stage by the air bearing 178. Both the X and Y reaction forces are supported by the reaction frames 148, but structurally decoupled from the platform 145 that supports the wafer stage base 144. Because the structure of the reaction frames 148 is isolated from the wafer stage base 144 on which the wafer stages 146 are supported in X, Y, and θ_{Z} directions, the reaction forces from the various actuators are effectively isolated from the wafer stages 146. The undesirable vibrations from reaction forces from actuations of one wafer stage 146 are minimized in accordance with the present invention, thus not affecting itself, the rest of the machine, and the other wafer stage 146. As in the previous embodiment, this embodiment also provides a reaction force isolation system that isolates reaction forces from X, Y and ⁰, actuations from the rest of the system by grounding such reaction forces via the reaction frame and isolating the reaction frame from the rest of the system.

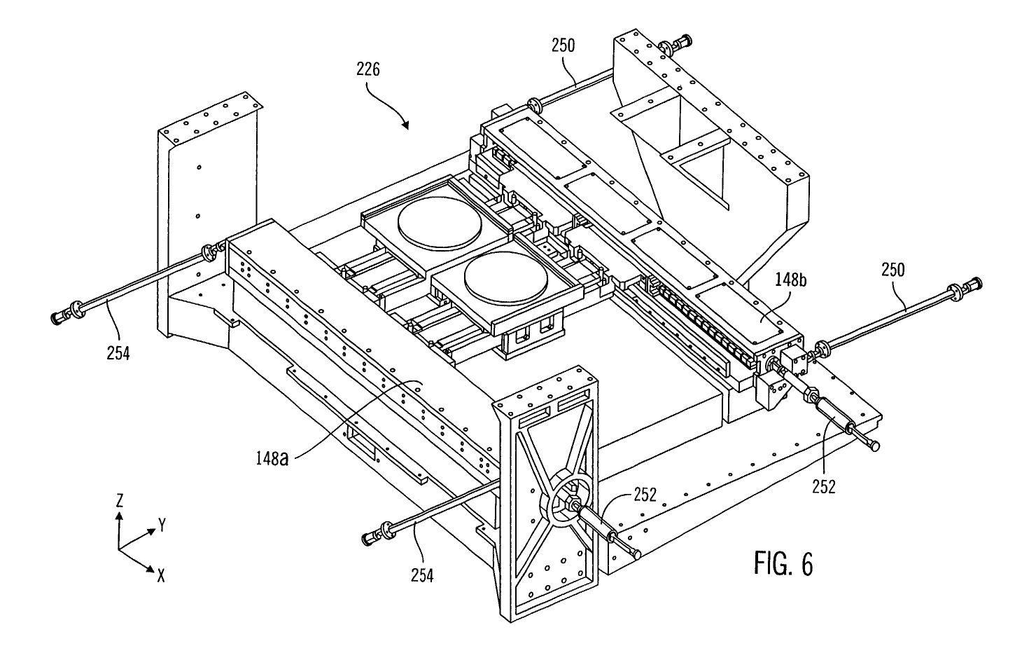

FIG. 6 shows another embodiment of a reaction frame configuration supporting a dual stage wafer stage assembly 226. This embodiment is in large part structurally similar to the embodiment shown in FIG. 4, except that additional reaction rods 254 are provided to ground the Y-direction reaction forces acting on the reaction frame 148a, in addition to the rods 250 for reaction frame 148b, and there are no interconnecting rods between the reaction frames 148a and 148b in this embodiment. The rods 250, 252 and 254 may be similar to rods 202 and 204 in the previous embodiment of FIG. 4.

There are a number of different types of lithographic devices in which the present invention may be deployed. For example, the exposure apparatus 10 can be used as scanning type photolithography system that exposes the pattern from the reticle 16 onto the wafer 12 with the reticle 16 and wafer 12 moving synchronously. In a scanning type lithographic device, the reticle 16 is moved perpendicular to an optical axis of the projection optics 24 by the reticle stage assembly 18 and the wafer 12 is moved perpendicular to an optical axis of the projection optics 24 by the wafer stage assembly (26, 126, 226). Scanning of the reticle 16 and the wafer 12 occurs while the reticle 16 and the wafer 12 are moving synchronously.

Alternately, the exposure apparatus 10 can be a step-and-repeat type photolithography system that exposes the reticle while the reticle 16 and the wafer 12 are stationary. In the step and repeat process, the wafer 12 is in a constant position relative to the reticle 16 and the projection optics 24 during the exposure of an individual field. Subsequently, between consecutive exposure steps, the wafer 12 is consecutively moved by the wafer stage (46, 146) perpendicular to the optical axis of the projection optics 24 so that the next field of the wafer 12 is brought into position relative to the projection optics 24 and the reticle 16 for exposure. Following this process, the images on the reticle 16 are sequentially exposed onto the fields of the wafer 12 so that the next field of the wafer is brought into position relative to the projection optics 24 and the reticle 16.

Further, the present invention can also be applied to a proximity photolithography system that exposes a mask pattern by closely locating a mask and a substrate without the use of a lens assembly.

The use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head.

The illumination source 15 can be g-line (436 nm), I-line (365 nm), KrF excimer laser (248 nm), ArF excimer laser (193 nm) and F₂ laser (157 nm). Alternately, the illumination source 15 can also use charged particle beams such as an x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

In terms of the magnification of the projection optics 24 included in the photolithography system, the projection optics 24 need not be limited to a reduction system. It could also be a 1× or magnification system.

With respect to the projection optics 24, when far ultra-violet rays such as the excimer laser is used, glass materials such as quartz and fluorite that transmit far ultraviolet rays is preferable to be used. When the F₂ type laser or x-ray is used, the lens assembly of the projection optics 24 should preferably be either catadioptric or refractive (a reticle should also preferably be a reflective type), and when an electron beam is used, electron optics should preferably consist of electron lenses and deflectors. The optical path for the electron beams should be in a vacuum. Further, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent applications and its counterpart U.S. Pat. No. 5,689,377 as well as Japan Patent Disclosure No 10-3039 and its counterpart U.S. Pat. No. 5,892,167 also use a reflecting-refracting type of optical system incorporating a concave mirror, etc., but without a beam splitter, and can also be employed with this invention. The disclosures in the abovementioned U.S. patents as well as the Japan patent applications published in the Official Gazette for Laid-Open Patent Applications are incorporated herein by reference. Further, in photolithography systems, when linear motors (see U.S. Pat. Nos. 5,623,853 or 5,528,118) are used in a wafer stage or a mask stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Alternatively, one or more of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,118 and 5,874,820 and Japanese Patent Application Disclosure No. 8-330224 are incorporated herein by reference.

As described above, a photolithography system according to the above-described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

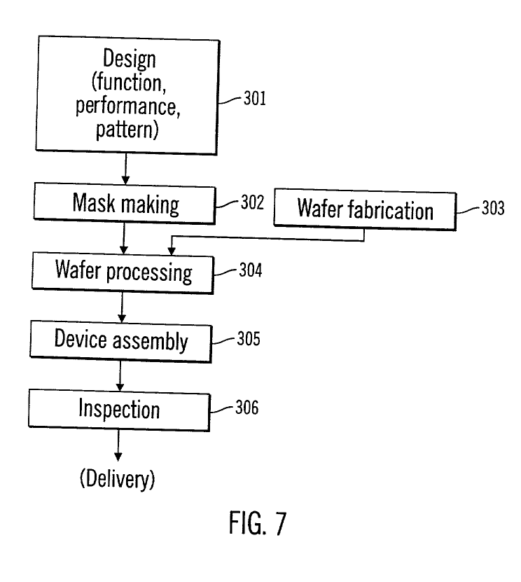

Further, semiconductor devices can be fabricated using the above described systems, by the process shown generally in FIG. 7. In step 301 the device's function and performance characteristics are designed. Next, in step 302, a mask (reticle) having a pattern is designed according to the previous designing step, and in a parallel step 303 a wafer is made from a silicon material. The mask pattern designed in step 302 is exposed onto the wafer from step 303 in step 304 by a photolithography system described hereinabove in accordance with the present invention. In step 305 the semiconductor device is assembled (including the dicing process, bonding process and packaging process), then finally the device is inspected in step 306.

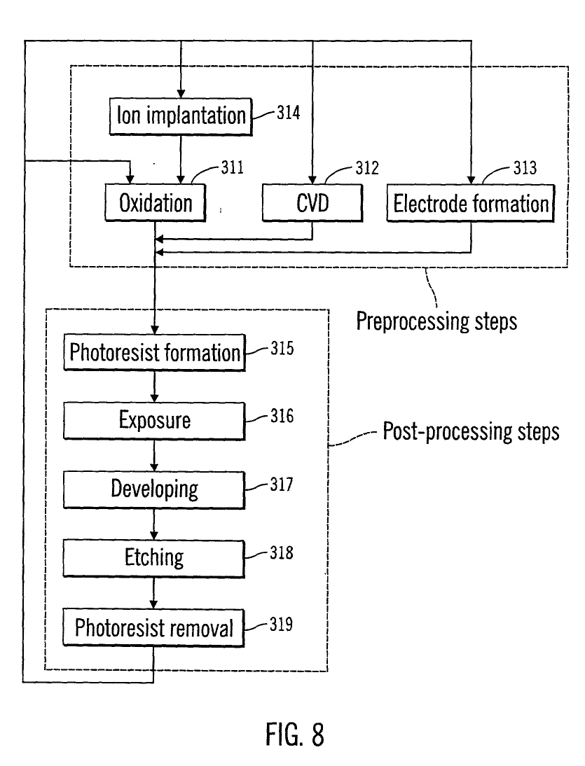

FIG. 8 illustrates a detailed flowchart example of the above-mentioned step 304 in the case of fabricating semiconductor devices. In FIG. 8, in step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above-mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 315 (photoresist formation step), photoresist is applied to a wafer. Next, in step 316 (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed.

Multiple circuit patterns are formed by repetition of these preprocessing and post-processing steps.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

1. A stage assembly, comprising:
a base;
a stage slidably movable on the base, in first and second directions and rotation in a plane;
a mover connected to the stage, the mover moving the stage in the plane, wherein reaction forces are created when the stage is being moved in the plane; and
a reaction frame supporting the mover, the reaction frame being structurally decoupled from the base with respect to at least reaction forces in one of the first and second directions.

2. A stage assembly as in claim 1, wherein the reaction frame supports the mover in a manner whereby reaction forces in the first direction are structurally decoupled from the reaction frame.

3. A stage assembly as in claim 2, wherein the reaction forces in the first direction are structurally decoupled from the reaction frame by providing a slidable coupling between the mover and the reaction frame.

4. A stage assembly as in claim 3, wherein the slidable coupling comprises an air bearing.

5. A stage assembly as in claim 2, wherein the reaction frame supports the mover further in a manner whereby reaction forces in the second direction are supported by the reaction frame.

6. A stage assembly as in claim 5, further comprising a support connected to the mover and ground substantially in the first direction.

7. A stage assembly as in claim 1, wherein the reaction frame supports the mover in a manner whereby reaction forces in both first and second directions are supported by the reaction frame.

8. A stage assembly as in claim 7, wherein the reaction frame is slidably coupled to the base.

9. A stage assembly as in claim 7, further comprising a support connected to the mover and ground substantially in at least one of the first and second directions.

10. A stage assembly as in claim 7, wherein the reaction frame comprises at least two frames that are spaced apart defining a region within which the stage is supported on the base, the stage assembly further comprising at least a flexible coupling between the frames defining the spacing between the frames.

11. A stage assembly as in claim 1, wherein the reaction frame is structurally decoupled from the stage with respect to reaction forces in at least one of the first and second directions by a slidable coupling between the reaction frame and either (a) a structure from which said reaction forces in said at least one of the first and second directions arise, or (b) a structure that is structurally coupled to the base.

12. A stage assembly as in claim 1, wherein the reaction frame is structured to be moveable in X, Y and θ_{Z} directions with respect to the base.

13. A stage assembly, comprising:
a base;
a stage slidably movable on the base;
a first drive device having a relatively fixed portion and a first moving portion coupled to a moving member in a first direction, wherein reaction forces are created between the first fixed portion and the first moving portion when the moving member is being moved in the first direction;
a second drive device having a second relatively fixed portion coupled to the moving member and a second moving portion coupled to a stage, the second drive device moving the stage in a second direction, wherein reaction forces are created between the second fixed portion and the second moving portion when the stage is being moved in the second direction; and
a reaction frame supporting the fixed portions of the first drive device, wherein the reaction frame is structurally decoupled from the stage at least with respect to reaction forces in the first direction.

14. A stage assembly as in claim 13, wherein the reaction frame supports the first drive device in a manner whereby reaction forces in the first direction are isolated from the reaction frame.

15. A stage assembly as in claim 14, wherein the reaction frame supports the relatively fixed portion of the first drive device by a slidable coupling.

16. A stage assembly as in claim 13, wherein the reaction frame supports the first fixed portion of the first drive device in a manner whereby reaction forces in both first and second directions are supported by the reaction frame.

17. A stage assembly as in claim 13, wherein the reaction frame is structurally decoupled from the stage with respect to reaction forces in at least one of the first and second directions by providing a slidable coupling between the reaction frame and either (a) the structure from which said reaction forces in said at least one of the first and second directions arise, or (b) a structure that is structurally coupled to the base.

18. A stage assembly as in claim 13, further comprising:
a third drive device having a third relatively fixed portion supported on the reaction frame and a third moving portion coupled to the moving member, the third drive device moving the moving member in the second direction, wherein reaction forces are created between the third fixed portion and the third moving portion when the moving member is being moved in the second direction.

19. A stage assembly as in claim 18, wherein the reaction frame supports the fixed portion of the third drive device in a manner whereby reaction forces in the second direction are supported by the reaction frame.

20. An exposure system comprising:
an illumination system that irradiates radiant energy; and
the stage assembly according to claim 13, said stage assembly carrying an object disposed on a path of said radiant energy.

21. A wafer on which an image has been formed by the exposure system of claim 20.

22. A device manufactured with the exposure apparatus of claim 18.
